(19) United States
(12) Patent Application Publication
(10) Pub. No.: US 2004/0196959 A1
(43) Pub. Date: Oct. 7, 2004

(54) Cooling system for cooling an X-ray tube

(76) Inventor: Lonnie Weston, Syracuse, UT (US)

Correspondence Address: MCANDREWS HELD & MALLOY, LTD, 500 WEST MADISON STREET, SUITE 3400, CHICAGO, IL, 60661

(21) Appl. No.: 10/406,684

(22) Filed: Apr. 3, 2003

(51) Int. Cl. H01J 35/10

(52) U.S. Cl. 378/141

(57) ABSTRACT

A cooling system including an X-ray tube, a cooling source, and a conduit carrying a fluid. The conduit has a first section disposed to extract heat from the X-ray tube and a second section disposed to have heat extracted by the cooling source. The X-ray tube heats the first section such that the fluid is evaporated from a liquid fluid into a gas fluid. The gas fluid flows from the first section to the second section to achieve equilibrium. The heat from the evaporated gas fluid is extracted from the conduit at the second section by the cooling source. The cooling source cools the second section such that the evaporated gas fluid condenses to liquid fluid. The liquid fluid is moved to the first section of the conduit by the gas fluid flowing from the first section to the second section.

### BACKGROUND OF THE INVENTION

The present invention relates to a cooling system for use with an X-ray machine. More particularly, certain embodiments of the present invention relate to a cooling system connected to a C-arm X-ray machine for cooling the X-ray tube during operation.

A conventional X-ray machine includes a glass insert mounted in a metal housing. The tube-shaped glass insert carries a filament that emits photons directed through the glass insert toward a patient. Because X-ray machines must be aimed at specific areas of a patient's body, X-ray machines may be mounted on an arm that can move about a standing or lying patient. For example, an X-ray machine may be mounted on the end of a large mobile C-shaped arm. The C-shaped arm may be positioned or rotated about the stationary patient such that the X-ray machine can be positioned to image a number of different areas of the patient's body.

A conventional X-ray machine generates a tremendous amount of heat during the course of its operation. In fact less than 2% of the energy supplied to an X-ray machine may actually be used to generate useful X-rays. The remainder of the energy is absorbed into the housing and transferred as heat. If an X-ray machine is operated for an extended period of time, the X-ray machine may give off so much heat that the metal housing becomes extremely hot, the glass insert cracks, or the components within the glass insert are damaged. Therefore, medical personnel are often forced to stop using the X-ray machine when the X-ray machine begins to generate too much heat.

However, because medical personnel want to keep an X-ray machine running as often and as long as possible in order that as many patients may be treated in a day as possible, cooling systems have been developed to increase the use life of the conventional X-ray machine. For example, one type of cooling system includes metal fins mounted on the X-ray machine and a fan that blows air on the fins. The fins increase the surface area carrying the heat from the x-ray machine. The air from the fan cools the fins such that the heat is extracted from the fins, thereby reducing the likelihood that the X-ray will overheat.

Another conventional cooling system uses heat exchangers to cool the X-ray machines. The heat exchanger system includes a metal plate that is mounted onto the X-ray machine. The metal plate includes tubing that is connected to a separate base unit by circulation lines that carry water. The base unit may be positioned somewhere on the floor below the X-ray machine, for example. The base unit includes a pump, a liquid reservoir, and a radiator. The water in the tubing in the metal plate is heated by the X-ray machine and the pump circulates the water through the circulation lines to the radiator. The radiator extracts heat from the water and then the water is recirculated back to the metal plate. In some cooling systems, the base unit may include a refrigeration system instead of a radiator.

However, conventional X-ray cooling systems suffer from several drawbacks. First, conventional X-ray cooling systems take up a considerable amount of space and include several components. For example, in the system using fins and a fan, the fan is mounted separately from the X-ray machine and takes up space when an operator is trying to position the C-shaped arm about a patient. Additionally, in the heat exchange system, the water must be pumped between the metal plate and the separate base unit along the circulation lines. The base unit and the circulation lines thus take up space and limit the movement of the C-shaped arm about the patient. Further, because the heat exchange system involves numerous interacting parts such as the pump, reservoir, and radiator, the heat exchange system is expensive and also prone to breakdowns.

A need exists for an improved cooling system for use with X-ray machines and in particular, X-ray machines mounted on a mobile C-shaped arm.

### BRIEF SUMMARY OF THE INVENTION

Certain embodiments of the present invention include a cooling system having an X-ray tube, a cooling source, and a conduit carrying a fluid. The conduit has a first section disposed to extract heat from the X-ray tube and a second section disposed to have heat extracted therefrom by the cooling source. Heat generated by the X-ray tube heats the first section such that the fluid is evaporated from a liquid fluid into a gas fluid. The gas fluid flows from the first section to the second section to achieve equilibrium. The heat from the evaporated gas fluid is extracted from the conduit at the second section by the cooling source. The cooling source cools the second section such that the evaporated gas fluid condenses to liquid fluid. The liquid fluid is moved to the first section of the conduit by the gas fluid flowing from the first section to the second section.

Certain embodiments of the present invention include a cooling system having an X-ray tube, a condensing chamber with a plurality of cooled fins, a conductive plate, and a conduit carrying a fluid. The conduit has a first section connected to the plate and a second section connected to the fins of the condensing chamber. The plate is disposed to extract heat from the X-ray tube and transfer the heat to the fluid in the conduit such that the fluid is evaporated from a liquid fluid into a gas fluid. The gas fluid flows from the first section of the conduit to the second section of the conduit where the heat from the evaporated gas fluid is extracted from the conduit by the fins. The fins cool the second section of the conduit such that the evaporated gas fluid condenses to liquid fluid. The liquid fluid flows to the first section of the conduit.

Certain embodiments of the present invention include a process for cooling an X-ray tube including extracting heat from an X-ray tube into a conductive plate and transferring the heat to liquid fluid in a conduit connected to the conductive plate such that the liquid fluid evaporates into a gas fluid. The gas fluid is circulated along the conduit to a condensing chamber. The heat is extracted from the gas fluid into cooled fins extending from the condensing chamber such that the gas fluid condenses into a liquid fluid. The liquid fluid is circulated along the conduit to the conductive plate.

### BRIEF DESCRIPTION OF SEVERAL VIEWS OF THE DRAWINGS

FIG. 1 illustrates an isometric view of a mobile X-ray machine-positioning arm, which incorporates a cooling system formed according to an embodiment of the present invention.

FIG. 2 illustrates an isometric view of a portion of the X-ray machine of FIG. 1, where the cover has been removed to show the X-ray tube and cooling system.

FIG. 3 illustrates an isometric view of a cooling system formed according to an embodiment of the present invention.

FIG. 4 illustrates a bottom view of the cooling system of FIG. 3.

FIG. 5 illustrates a cross-sectional view of the cooling system of FIG. 3 taken along lines 5-5.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentality shown in the attached drawings.

### DETAILED DESCRIPTION OF THE INVENTION

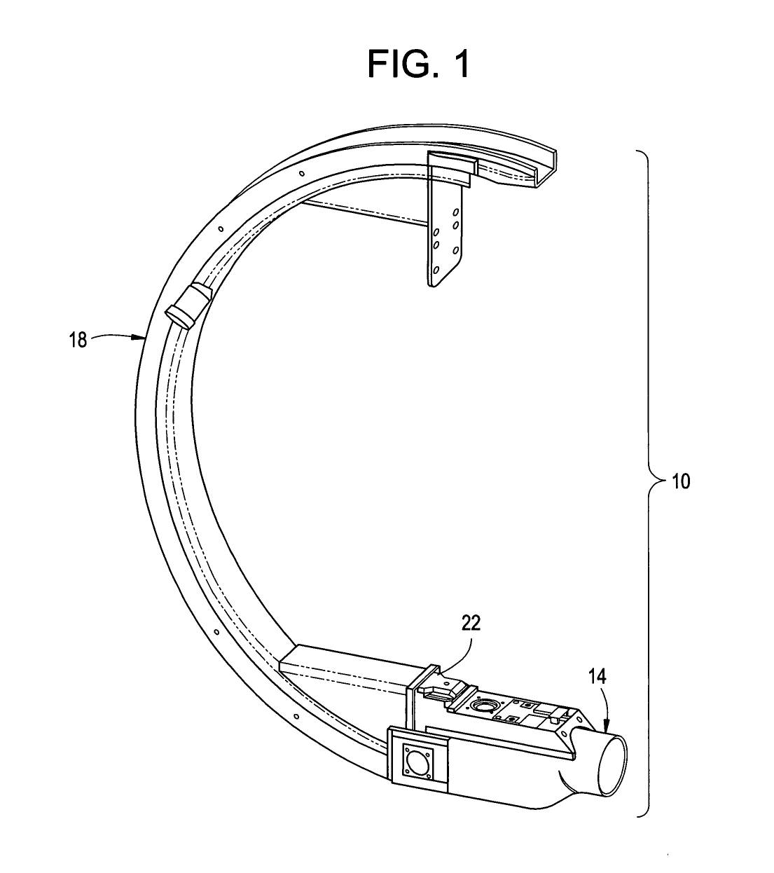

FIG. 1 illustrates an isometric view of a mobile X-ray machine-positioning arm 10, which incorporates a cooling system according to certain aspects of the present invention. The X-ray machine-positioning arm 10 includes an X-ray tube 14 mounted on an end of a large metal C-arm 18. A protective covering 22 is mounted over the X-ray tube 14. In operation, the C-arm 18 can be positioned about a patient to orient the X-ray tube 14 for imaging a particular area of the patient's body.

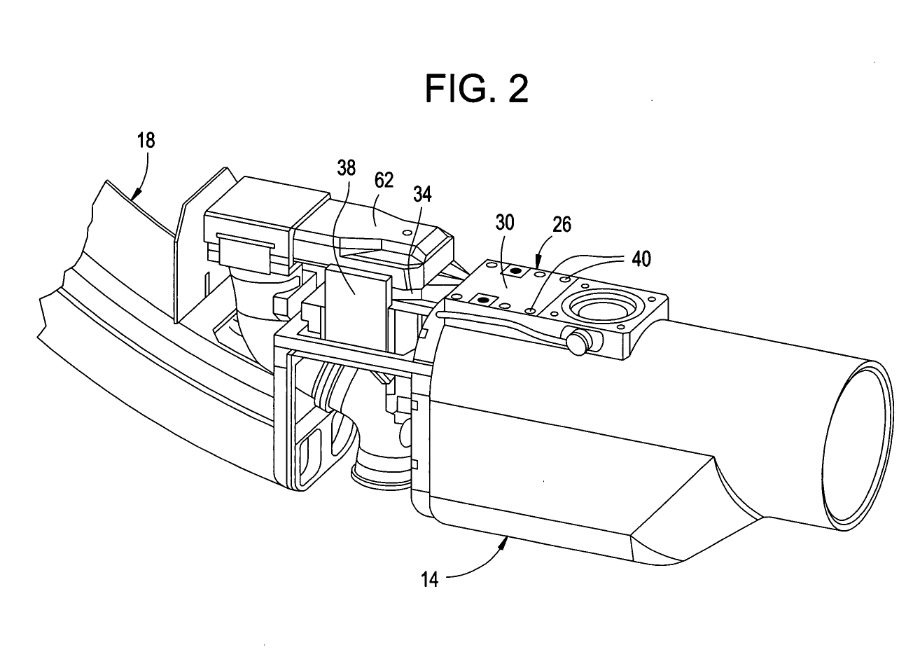

FIG. 2 illustrates an isometric view of the X-ray tube 14 with the covering 22 (FIG. 1) removed. A cooling system 26 is mounted on the exposed X-ray tube 14. The cooling system 26 includes a conductive evaporator plate 30 that is connected to the X-ray tube 14. In the illustrates embodiment, the evaporator plate 30 is connected to the X-ray tube 14 by fasteners, such as bolts (not shown), that extend through apertures 40 in the evaporator plate 30 and thread into reciprocal apertures (not shown) in the X-ray tube 14. Tubes 34 extend from the evaporator plate 30 to a condensing chamber 38 at a location distal of the X-ray tube 14. A ventilation duct 62 extends over the condensing chamber 38. The ventilation duct 62 includes a fan (not shown) that draws in air from the outside environment and blows cool air at the condensing chamber 38. The cooling system 26 and the ventilation duct 62 operate as a heat pipe to cool the X-ray tube 14.

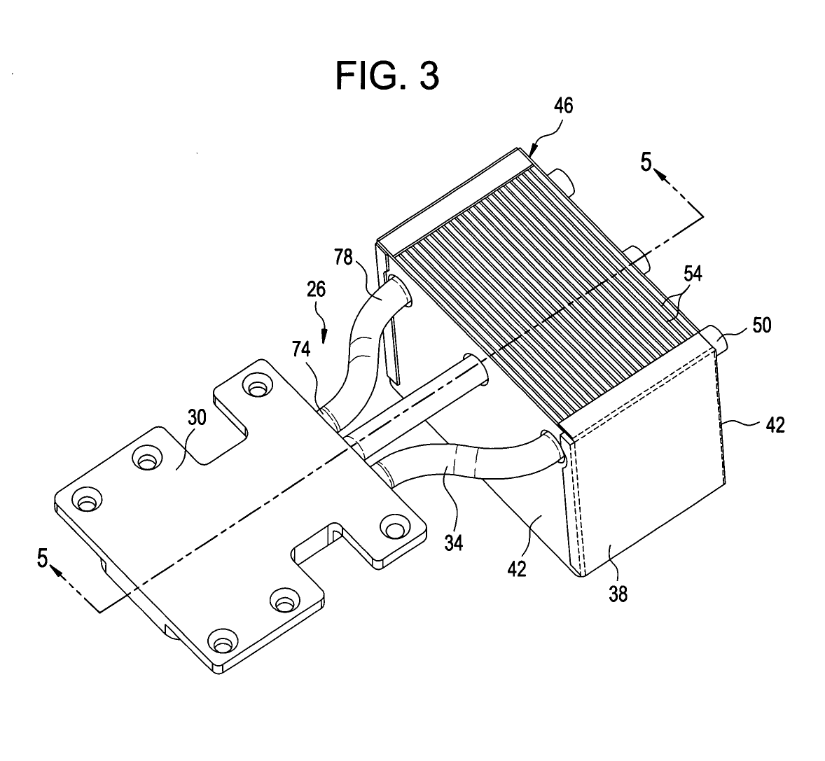

FIG. 3 illustrates an isometric view of the cooling system 26 formed according to an embodiment of the present invention. The evaporator plate 30 is generally square, planar in shape, and made of metal. The condensing chamber 38 is metal and generally box-shaped and has a plurality, or series, of thin, metal parallel fins 54 that extend into the interior of the condensing chamber 38 from along a top end 46 thereof. The tubes 34 are hollow conduits that carry a fluid, preferably water. The tubes-34 are made of metal. By way of example only, the tubes 34 are copper. The interior surface area of each tube 34 is sintered to leave a porous capillary of metal, or wick (not shown), on the inside of the tubes 34. The tubes 34 have first sections 74 that extend through the evaporator plate 30 and have second sections 78 that extend through parallel side walls 42 and the fins 54 of the condensing chamber 38 proximate the top end 46. The tubes 34 have sealed ends 50 that extend out of the condensing chamber 38 opposite the evaporator plate 30.

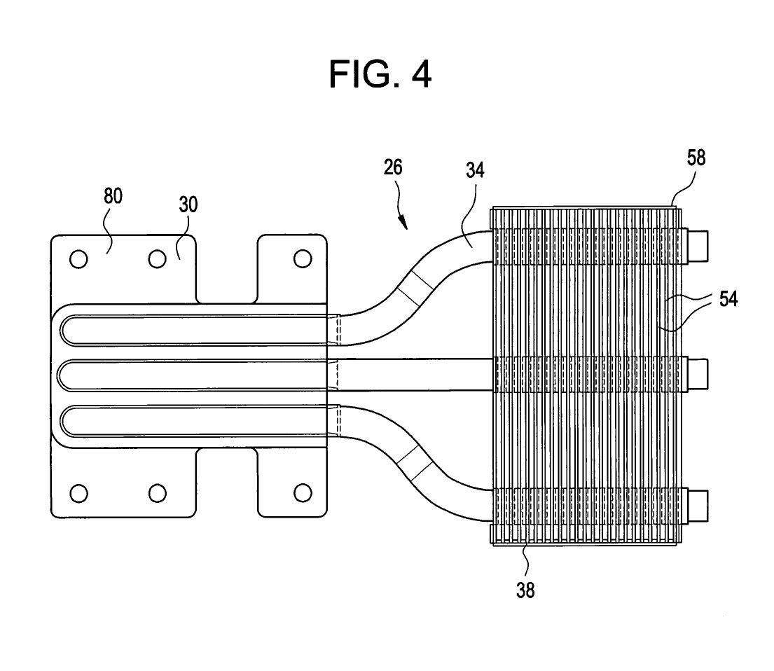

FIG. 4 illustrates a bottom view of the cooling system 26 of FIG. 3. The fins 54 extend throughout the condensing chamber 38 from the top end 46 of (FIG. 3) the condensing chamber 38 to a bottom end 58 of the condensing chamber 38. The hollow tubes 34 extend along a bottom surface 80 of the evaporator plate 30 and through the series of fins 54 within the condensing chamber 38 such that a flow path is formed from the evaporator plate 30 to the condensing chamber 38.

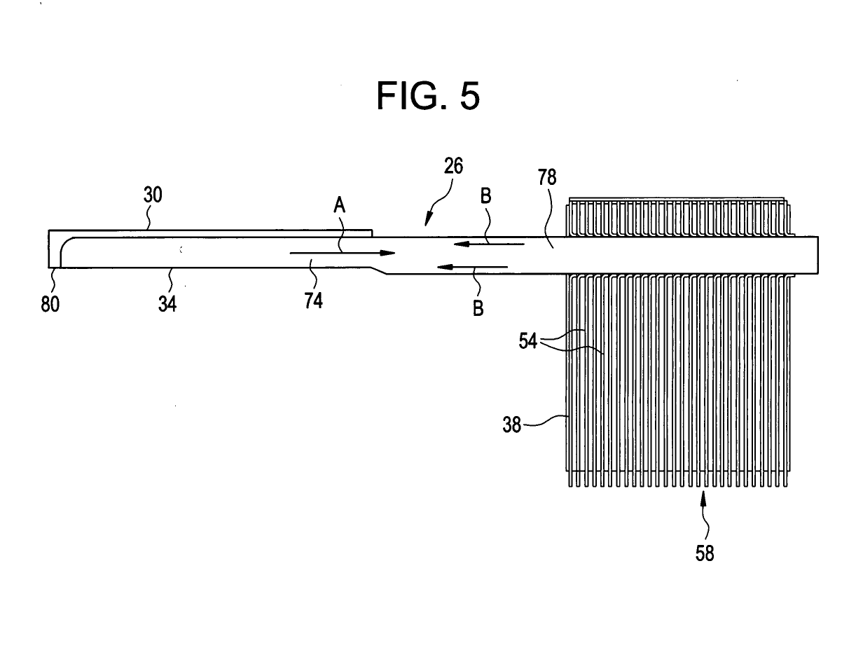

FIG. 5 illustrates a cross-sectional view of the cooling system 26 of FIG. 3 taken along lines 5-5. In operation, the X-ray tube 14 (FIG. 2) carries a filament that becomes very hot during use. Heat from the X-ray tube 14 is transferred by conductance to the evaporator plate 30. The evaporator plate 30 heats the liquid inside the first sections 74 of the tubes 34 that extend along the bottom surface 80 of the evaporator plate 30. The heat evaporates the liquid into a gas within the tubes 34 and the gas then flows away from the heat source to a cooler area in order to achieve thermal equilibrium. Thus, the gas flows in the direction of arrow A down the center of the tubes 34 toward the condensing chamber 38.

The ventilation duct 62 (FIG. 2) passes cool air over the fins 54 at the top end 46 of the condensing chamber 38 such that the fins 54 are cooled. As the gas flows in the second sections 78 of the tubes 34 through the condensing chamber 38, the gas travels through the series of fins 54. Heat is extracted from the gas through the tubes 34 into the fins 54, and the circulating air draws the heat from the fins. As heat is extracted from the gas, the gas inside the tubes 34 cools and condenses into liquid. Because the tubes 34 are connected to many fins 54 and the fins 54 extend throughout the condensing chamber 38, the heat transferred to the fins 54 from the gas is spread out over a large surface area and the fins 54 are quickly cooled by the ventilation duct 62. The air that is heated upon flowing past the warmed fins 54 is circulated out of the bottom end 58 of the condensing chamber 38 and away from the X-ray tube 14 (FIG. 2). Thus, the condensing chamber 38 in combination with the ventilation duct 62 serves as a cooling source for the tubes 34.

The liquid created by the heat transfer in the condensing chamber 38 flows along the sintered material, or wick, extending along the interior surface of the tubes 34 back to the evaporator plate 30 in the direction of arrows B in the opposite direction of the gas. The liquid travels along the interior surface of the tubes 34 as a “ring” while the gas travels in the opposite direction through the center of the ring of liquid.

The cooling system 26 transports heat against gravity by an evaporation-condensation cycle with the help of the porous capillaries that form the wick. The heated gas has a higher pressure than the liquid and will naturally flow from a hot area to a cool area. That is the principle whereby heat seeks thermodynamic equilibrium when it comes in contact with cold. In other words, heat transfers to cold. The movement of the hot evaporated gas from the heated evaporator plate 30 to the cooled condensing chamber 38 causes the circulation of the gas through the tubes 34. The movement of the gas in turn forces the liquid to circulate in the opposite direction. The wick provides the capillary path to return the condensed liquid to the evaporator as a ring along the interior of the tubes 34. Once the cooled liquid has flowed from the condensing chamber 38 to the evaporator plate 30, the liquid is then gradually heated by the evaporator plate 30 and the cycle of heat transfer begins again.

In operation, the cooling system 26 extracts heat from the X-ray tube 14 and transfers the heat to the condensing chamber 38 positioned away from the X-ray tube 14 where the heat is released along the fins 54. The cooling system 26 thus allows the X-ray tube 14 to operate for long periods of time without the risk of the X-ray tube 14 overheating, and medical professionals may use the X-ray machine 10 for long periods of time without work stoppage.

As will be appreciated by those skilled in the art, in alternative embodiments, the cooling system 26 may be used with many different kinds of X-ray machines besides a mobile C-arm X-ray machine.

In an alternative embodiment, the second sections 78 of the tubes 34 may be cooled by any number of different cooling methods. For example, the condensing chamber 38 may carry a fan therein that cools the fins 54 instead of being positioned proximate an external duct that circulates air. Alternatively, the fins 54 may be cooled by a different cooling source than a fan, such as refrigeration device. Alternatively, the condensing chamber 38 may carry a refrigerating device or fan that cools the second sections 78 of the tubes 34 directly without the use of fins 54. Alternatively, the tubes 34 may not be connected to a condensing chamber 38, but may be directly connected to a refrigerating device or positioned in the path of cooled air.

In an alternative embodiment, the tubes 34 may be able to transfer heat from the X-ray tube 14 without the use of an evaporator plate 30. For example, the tubes 34 may be individually mounted upon or within the x-ray tube 14.

In an alternative embodiment, the evaporator plate 30 may contain an inner reservoir that is directly connected to the tubes 34 such that a flow path exists between the reservoir and the interior of the tubes 34. The tubes 34 thus may carry liquid to and from the reservoir.

In an alternative embodiment, the tubes 34 may carry a fluid other than water for heat transfer or may use a combination of water with another fluid. For example, the tubes 34 may carry ethanol.

In an alternative embodiment, the tubes 34 may be made of aluminum or another substance.

The cooling system of the various embodiments confers several benefits. First, because the cooling system is small and entirely enclosed within one module, the cooling system takes up less room around the X-ray tube than a cooling system that includes a separate pump, radiator, reservoir, or circulation line. Also, the entire cooling system fits under the X-ray tube covering without connections to an external base unit. Therefore, the cooling system does not impede the movement of the C-arm and affect the treatment of a patient. Additionally, because the heat pump uses only a few simple parts, it is less expensive and less prone to breakdowns than cooling systems that include pumps, reservoirs, and radiators.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A cooling system comprising:
an X-ray tube;
a cooling source;
a conduit carrying a fluid, said conduit having a first section disposed to extract heat from said X-ray tube and a second section disposed to have heat extracted therefrom by said cooling source, said X-ray tube heating said first section such that the fluid is evaporated from a liquid fluid into a gas fluid, the gas fluid flowing from said first section to said second section to achieve equilibrium, the heat from the evaporated gas fluid being extracted from said conduit at said second section by said cooling source, said cooling source cooling said second section such that the evaporated gas fluid condenses to liquid fluid, the liquid fluid being moved to said first section of said conduit by the gas fluid flowing from said first section to said second section; and
an evaporator plate integrally connected to said conduit at said first section, said evaporator plate overlying at least a portion of said X-ray tube such that said evaporator plate extracts heat from said X-ray tube.

2. The cooling system of claim 1, wherein said cooling source is a condensing chamber carrying a plurality of cooled fins, said second section of said conduit passing through said condensing chamber and said cooled fins such that heat is extracted from said second section of said conduit by said fins.

3. The cooling system of claim 1, wherein said cooling system includes a plurality of conduits.

4. The cooling system of claim 1, wherein said conduit extends along a bottom surface of said evaporator plate.

5. The cooling system of claim 1, wherein said cooling source includes a plurality of parallel fins that are cooled by a fan, said second section of said conduit connected to said fins such that heat is extracted from said second section of said conduit by said fins.

6. The cooling system of claim 1, wherein said conduit is a tube formed of copper.

7. The cooling system of claim 1, wherein said conduit is a tube formed of aluminum.

8. The cooling system of claim 1, wherein said conduit has been sintered along an interior wall thereof such that said interior wall carries liquid fluid therealong.

9. The cooling system of claim 1, wherein said conduit has a wick along an interior wall thereof such that said interior wall carries liquid fluid from said second section of said conduit to said first section of said conduit.

10. The cooling system of claim 1, wherein the liquid is water.

11. (Cancelled)

12. A cooling system comprising:
an X-ray tube;
a condensing chamber having a plurality of cooled fins;
a conductive plate;
a conduit carrying a fluid, said conduit having a first section connected to said plate and a second section connected to said fins of said condensing chamber, said plate being disposed to extract heat from said X-ray tube and transfer the heat to the fluid in said conduit such that the fluid is evaporated from a liquid fluid into a gas fluid, said conduit being configured such that the gas fluid flows from said first section of said conduit to said second section of said conduit where heat from the evaporated gas fluid is extracted from said conduit by said fins, said fins cooling said second section of said conduit such that the evaporated gas fluid condenses to liquid fluid, said conduit being configured such that the liquid fluid flows from said second section of said conduit to said first section of said conduit; and
an evaporator plate integrally connected to said conduit at said first section, said evaporator plate overlying at least a portion of said X-ray tube such that said evaporator plate extracts heat from said X-ray tube.

13. The cooling system of claim 12, wherein said cooling system includes a plurality of conduits.

14. The cooling system of claim 12, wherein said fins are cooled by a fan.

15. The cooling system of claim 12, wherein the liquid is water.

16. The cooling system of claim 12, wherein said conduit has been sintered along an interior wall thereof such that said interior wall carries liquid fluid therealong.

17. The cooling system of claim 12, wherein said conduit includes a wick along an interior wall thereof such that said interior wall carries liquid fluid from said second section of said conduit to said first section of said conduit.

18. The cooling system of claim 12, wherein the liquid is ethanol.

19. The cooling system of claim 12, wherein the gas fluid flows from said first section of said conduit to said second section of said conduit to achieve equilibrium and causes the liquid fluid to flow from said second section of said conduit to said first section of said conduit.

20. A process for cooling an X-ray tube comprising:
extracting heat from an X-ray tube into a conductive plate;
transferring the heat to liquid fluid in a conduit connected to said conductive plate such that the liquid fluid evaporates into a gas fluid;
circulating the gas fluid along said conduit to a condensing chamber;
extracting heat from the gas fluid into cooled fins extending from said condensing chamber such that the gas fluid condenses into a liquid fluid; and
circulating the liquid fluid along said conduit to said conductive plate.
